(19) United States
(12) Patent Application Publication
(10) Pub. No.: US 2023/0168135 A1
(43) Pub. Date: Jun. 1, 2023

(54) DISTRIBUTED FIBER TEMPERATURE MEASUREMENT DEVICE, AND PHOTOVOLTAIC POWER STATION TEMPERATURE MEASUREMENT SYSTEM AND METHOD

(71) Applicants: SHANDONG MICRO-SENSOR PHOTONICS LIMITED, Jinan (CN); GUANGDONG LASER SENSOR TECHNOLOGY CO. LTD., Foshan (CN)

(72) Inventors: Tongyu LIU, Jinan (CN); Tao JIANG, Jinan (CN); Yanong NING, Jinan (CN); Zhidong SHI, Jinan (CN); Guangxian JIN, Jinan (CN); Zhenya LIU, Jinan (CN)

(73) Assignees: SHANDONG MICRO-SENSOR PHOTONICS LIMITED, Jinan (CN); GUANGDONG LASER SENSOR TECHNOLOGY CO. LTD., Foshan (CN)

(21) Appl. No.: 17/559,010

(22) Filed: Dec. 22, 2021

Related U.S. Application Data
(63) Continuation of application No. PCT/CN2021/134876, filed on Dec. 1, 2021.

(51) Int. Cl. G01K 11/32; H02S 50/00

(52) U.S. Cl. CPC G01K 11/32; H02S 50/00

(57) ABSTRACT

A distributed fiber temperature measurement device includes a temperature measurement module and temperature measurement fibers. The temperature measurement fiber includes alternately arranged sensing and isolation fibers. The sensing fibers are coiled in a fiber clamp holder to constitute temperature measurement sensing surfaces of temperature measurement points. The isolation fibers are coiled on a back side of the fiber clamp holder to constitute an isolation fiber storage region. A distance between the adjacent temperature measurement points is adjusted by releasing and storing the isolation fibers in the isolation fiber storage region. The temperature measurement module is connected to the temperature measurement fibers to obtain temperature measurement points temperatures. An environment temperature of a fiber clamp holder accessory corresponding to the isolation fibers is measured by the isolation fibers, and the sensing fibers of the adjacent measurement points are isolated by isolation fibers.

### TECHNICAL FIELD

The present invention relates to the technical field of distributed fiber temperature measurement, and in particular, to a distributed fiber temperature measurement device, and a photovoltaic power station temperature measurement system and method.

### BACKGROUND

The description in this section merely provides background information related to the present invention and does not necessarily constitute the prior art.

Hot-spot is a phenomenon that is known to occur in photovoltaic cell under fault conditions such as partial shading, material imperfection, fabrication flaws or damages to the photovoltaic cell itself. A hot-spot would cause fire on the solar panels installed on roofs. To prevent the overheat on the solar panels or associated electronic devices needs a sensor that can cover a large area of the solar power station.

A distributed fiber temperature measurement system is a technology for real-time measurement of temperature spatial distribution along a sensing fiber, which can be widely used for temperature measurement and fire detection/alarm in coal mines, tunnels, large buildings, transmission cables, cable bridges, etc. The distributed fiber temperature measurement system is a temperature sensing system, which mainly uses the principle of spontaneous Raman scattering in a fiber to measure temperature along the sensing fiber and uses the principle of optical time-domain reflection for positioning to implement measurement of a temperature field.

In the field of solar photovoltaic power generation, within a certain power generation region, the number of solar photovoltaic panels is very large, and an area occupied by photovoltaic panel module is very large as well. To measure the temperature over a large area and cover a large number of solar photovoltaic panels and the associated electronic devices such as cables, connectors, junction boxes and inverters is very difficult with the use of existing electronic temperature measurement sensors. Also, when both the temperature and location of each photovoltaic panel and other devices involved need to be separately measured and accurately positioned, a new methodology or sensor is required. Thus, in order to detect the hot-spot on the photovoltaic panels and/or other devices which may have potential of catching fire in time, the methodology disclosed can be used to achieve the purpose of preventing the photovoltaic panels and/or other devices from catching a fire.

### SUMMARY

In order to solve the above-mentioned problems, the disclosed invention proposes a distributed fiber temperature measurement device, and a photovoltaic power station temperature measurement system and method, in which a sensing fiber for temperature measurement is mounted in an independent fiber clamp holder to constitute a temperature measurement sensing surface of a single temperature measurement element or point, with which a temperature of the single temperature measurement point can be measured. Adjacent temperature measurement points are isolated by isolation fibers and the lengths of the sensing fibers can be adjusted to fit with different electronic devices according the applications involved. The sensing fiber can detect heat at any point along its length and provide an accurate location of any fires or events, providing the early warning information for operator to take action to prevent a potential fire.

To achieve the foregoing objective, the present invention uses the following technical solutions:

According to a first aspect, the present invention provides a distributed fiber temperature measurement device, including: a temperature measurement module and a group of temperature measurement fibers. The temperature measurement fiber consists of sensing fibers and isolation fibers which are arranged alternately at intervals.

The sensing fibers are arranged in a fiber clamp holder to constitute temperature measurement sensing surfaces of temperature measurement points.

The isolation fibers are arranged on a back side of the fiber clamp holder to constitute a fiber storage region, and the lengths of the sensing fibers are adjusted by releasing and storing the isolation fibers in the fiber storage region.

The temperature measurement module is connected to the group of temperature measurement fibers, so as to obtain temperatures of the temperature measurement points along each temperature measurement fiber separately.

As an optional implementation, the sensing fibers are coated with heat conducting materials and arranged in the fiber clamp holder according to a preset shape after being fixed with heat conducting metal.

As an optional implementation, the isolation fibers are arranged on the back side of the fiber clamp holder according to a preset shape and thermally isolated from the fiber clamp holder using a thermal insulation material.

As an optional implementation, the isolation fibers isolate the adjacent temperature measurement points, and the temperature measurement module is connected to the isolation fibers, so as to obtain an environment temperature between the adjacent temperature measurement points.

As an optional implementation, the fiber clamp holder is fixed on a surface of an object to be measured through a matched clamping frame or clamping pins, so that the temperature measurement sensing surface is attached to the surface of the object to be measured to perform temperature measurement.

As an optional implementation, the object to be measured may be a photovoltaic panel, cables, a cable connector, a junction box or an inverter.

According to a second aspect, the present invention provides a temperature measurement system that can monitor the temperature of a photovoltaic power station, including a fiber temperature measurement sensing device according to the first aspect and a processing module.

A fiber clamp holder of the fiber temperature measurement sensing device is arranged on an object to be measured of the photovoltaic power station, and a temperature measurement module acquires a temperature of the object to be measured.

The processing module is configured to judge an abnormal temperature value according to the temperature of the object to be measured, and position an abnormal object to be measured according to a location of the fiber clamp holder with the abnormal temperature value.

As an optional implementation, the object to be measured may be a photovoltaic panel, cables, a cable connector, a junction box or an inverter.

As an optional implementation, a grading alarm threshold is preset in the processing module, a grading alarm is given according to a comparison result between the temperature of the object to be measured and the grading alarm threshold, and if a first-grade alarm threshold is exceeded, an alarm program is started, and the corresponding object measured is positioned for maintaining or repairing.

As an optional implementation, a constant temperature alarm threshold is preset in the processing module, if the temperature of the object to be measured is greater than the constant temperature alarm threshold, an alarm program is started, and the corresponding object measured is positioned for maintaining or repairing.

As an optional implementation, a differential temperature alarm threshold is preset in the processing module, if a temperature difference between the objects to be measured is greater than the differential temperature alarm threshold, an alarm program is started, and the corresponding object measured is positioned for maintaining or repairing.

According to a third aspect, the present invention provides a measurement method adopting the photovoltaic power station temperature measurement system according to the second aspect, including:

collecting all temperature values of different objects to be measured in a photovoltaic power station through a group of temperature measurement fibers; the object to be measured may be a photovoltaic panel, cables, a cable connector, a junction box or an inverter.

presetting a grading alarm threshold, a constant temperature alarm threshold and a differential temperature alarm threshold, and judging an abnormal temperature value according to the temperature of the object measured; and

positioning an abnormal object measured according to a location of a fiber clamp holder with the abnormal temperature value along the temperature measurement fiber, and giving a corresponding grading alarm, constant temperature alarm, differential temperature alarm and the location of the corresponding object measured for maintenance.

Compared with the prior art, the beneficial effects of the present invention are as follows:

According to the distributed fiber temperature measurement device provided by the present invention, sensing fibers for temperature measurement are mounted in an independent fiber clamp holder to constitute a temperature measurement sensing surface of a single temperature measurement point, and a temperature of the single temperature measurement point can be measured. Adjacent temperature measurement points are isolated by isolation fibers; and the lengths of the sensing fibers are adjusted, so that the sensing fibers at a certain temperature measurement point can centrally measure the temperature of this point to ensure the accuracy of temperature measurement.

According to the photovoltaic power station temperature measurement system and method based on the distributed fiber temperature measurement device provided by the present invention, an abnormal temperature value can be judged according to a temperature of an object measured in the photovoltaic power station, such as, a photovoltaic panel, a cable connector, a junction box or an inverter, and an object with the abnormal temperature, such as, a photovoltaic panel can be positioned according to a location of a fiber clamp holder with the abnormal temperature value, so as to solve the problem of not accurately positioning each object measured or each photovoltaic panel in the prior art.

The photovoltaic power station temperature measurement system and method based on the distributed fiber temperature measurement device provided by the present invention can be used for measuring the temperature of a large area and a large number of objects to be measured, such as photovoltaic panels. The temperature of each object to be measured can be monitored in real time, high-temperature points or overheated object to be measured can be found and positioned in a large number of photovoltaic panel arrays in time, a grading alarm is given in time, the location of the overheated object measured is determined, and accidents are eliminated, so as to achieve the purpose of early warning of overheating of the object to be measured and preventing power station from fire.

Additional advantages of the present invention will be given in the following description, some of which will become apparent from the following description or may be learned from practices of the present invention.

### BRIEF DESCRIPTION OF THE DRAWINGS

The accompanying drawings constituting a part of the present invention are used to provide a further understanding of the present invention. The exemplary examples of the present invention and descriptions thereof are used to explain the present invention, and do not constitute an improper limitation of the present invention.

FIG. 1 is a schematic diagram of a distributed fiber temperature measurement device provided in Embodiment 1 of the present invention.

FIG. 2 is a flowchart of a measurement method adopting a photovoltaic panel temperature measurement system provided in Embodiment 3 of the present invention.

### DETAILED DESCRIPTION

The present invention is further described below with reference to the accompanying drawings and embodiments.

It should be noted that, the following detailed descriptions are all exemplary, and are intended to provide further descriptions of the present disclosure. Unless otherwise specified, all technical and scientific terms used herein have the same meanings as those usually understood by a person of ordinary skill in the art to which the present disclosure belongs.

It should be noted that the terminology used herein is for the purpose of describing specific implementations only and is not intended to be limiting of exemplary implementations of the present invention. As used herein, unless the context clearly indicates otherwise, the singular form is also intended to include the plural form. In addition, it should also be understood that, the terms “comprise”, “include”, and any other variants thereof mean to cover the non-exclusive inclusion. For example, a process, method, system, product, or device that includes a list of steps or units is not necessarily limited to those steps or units that are clearly listed, but may include other steps or units not expressly listed or inherent to such a process, method, system, product, or device.

The embodiments in the present prevention and features in the embodiments may be combined with each other in the case of no conflict.

### Embodiment 1

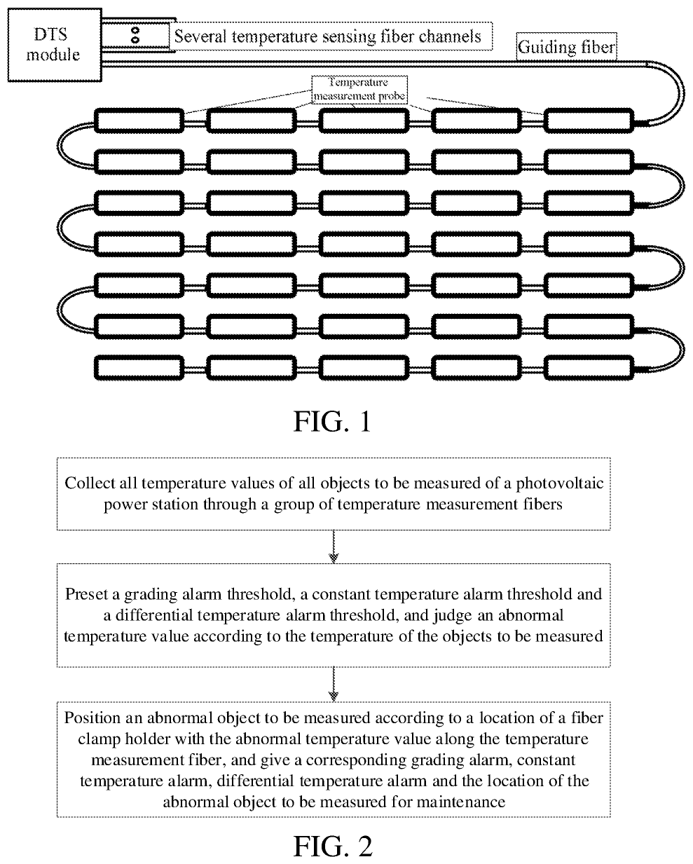

The present embodiment provides a distributed fiber temperature measurement device, as shown in FIG. 1, including: a temperature measurement module and a group of temperature measurement fibers. Each temperature measurement fiber is divided into a section of guiding fiber, and several sections of sensing fiber and isolation fiber which are interlaced with each other.

A section of sensing fiber is coiled in a sensing fiber storage region of a sensing surface in a fiber clamp holder to constitute temperature measurement sensing surfaces of temperature measurement points. By adjusting the lengths of the sensing fiber in the fiber clamp holder, the sensitivity of temperature measurement can be effectively adjusted.

A section of isolation fiber is coiled on a back side of the fiber clamp holder to constitute an isolation fiber storage region, and a relative distance between the adjacent temperature measurement points is adjusted by releasing and storing the isolation fibers in the isolation fiber storage region.

The temperature measurement module is connected to the group of temperature measurement fiber, so as to obtain temperatures of the temperature measurement points along each temperature measurement fiber separately.

As an optional implementation, the length of the guiding fiber is determined by actual engineering requirements, thereby avoiding measurement dead zones of a DTS while providing a reference temperature point. The lengths of the sensing fibers are determined by temperature measurement sensitivity, and high sensitivity is achieved by increasing the lengths of the sensing fibers. The lengths of the isolation fibers are determined by the length of a fiber capable of distinguishing two temperature measurement points and engineering construction requirements, and a distance between the two temperature measurement points is changed by releasing or storing the isolation fibers in the isolation storage region.

In the present embodiment, the sensing fibers are coiled into a shape required for temperature measurement, the coiled sensing fibers are mounted in the fiber clamp holders, and the sensing fibers are coated with heat conducting materials and fixed with heat conducting metal sheets to constitute measurement surfaces or sensing surfaces of the temperature measurement points.

As an optional implementation, the shape of the coiled sensing fibers required for temperature measurement includes a circle, a rectangle, or any other shapes.

As an optional implementation, the coiled sensing fibers may be a section of sensing fiber or a circle of sensing fiber or several circles of sensing fiber. One coiled sensing fiber serves as one temperature measurement point, and the length of the coiled sensing fiber is greater than a preset length, which is set to be a few meter in the present embodiment.

As an optional implementation, the radius of a curve of the sensing fiber is greater than a preset minimum radius. In the present embodiment, the preset minimum radius is set to 5 mm. As the radius of the curve of the sensing fiber is smaller, a temperature measurement effect is better.

In the present embodiment, the isolation fibers are coiled into a shape required for fiber placement, the coiled isolation fibers are mounted on the back side of the fiber clamp, and the isolation fibers are thermally isolated from the fiber clamp holder using a thermal insulation material.

As an optional implementation, the shape of the coiled isolation fibers required for fiber placement includes a circle, a rectangle, or any other shapes.

As an optional implementation, the radius of a curve of the isolation fiber is greater than a preset minimum radius. In the present embodiment, the preset minimum radius is set to 5 mm.

As an optional implementation, the isolation fibers in the fiber storage region may be used to measure an environment temperature of the temperature measurement points.

As an optional implementation, the sensing fiber surface in the fiber clamp holder is closely attached to a surface of an object to be measured so as to measure a temperature of the object to be measured, and the distance between adjacent temperature measurement points is adjusted by releasing or storing the isolation fibers, so that the environment temperature between the adjacent temperature measurement points may also be sensed through the isolation fibers. Meanwhile, the adjacent temperature measurement points are connected by the isolation fibers, so that the isolation fibers may measure a temperature of an actual space between the adjacent temperature measurement points.

As an optional implementation, the object to be measured may be a photovoltaic panel, a cable, a connector, a junction box or an inverter. The isolation fibers may measure a temperature between a photovoltaic panel and another photovoltaic panel, or a connect cable, or a junction box, an inverter, or the like.

In the present embodiment, an actual spatial distance between the adjacent temperature measurement points is adjusted by releasing the isolation fibers in the isolation fiber storage region or storing excess isolation fibers in the fiber storage region. Therefore, the actual spatial distance between each two temperature measurement points may be adjusted according to specific application requirements, and may be any distance of several millimeters, several meters, several tens of meters or more.

In the present embodiment, the fiber clamp holder of each temperature measurement point is provided with a matched clamping frame/clamping pins, and the fiber clamp holder is fixed on the surface of the object to be measured, such as a surface to be measured on a back side of the photovoltaic panel, through the clamping frame/clamping pins. After the fiber clamp holder is fixed on the object to be measured through a clamping lock of the clamping frame or clamping pins, the measuring surface or sensing surface of the fiber clamp holder is closely attached to the surface of the object to be measured, so as to achieve the purpose of measuring the surface temperature of the object to be measured.

In the present embodiment, the temperature measurement module may include a pulse light source, a high-speed optical switch, a fiber beam splitter, a high-sensitivity photoelectric detector, and a high-speed signal processing circuit, etc. A distributed Raman temperature measurement system disclosed in Chinese patent CN 108414113B may be specifically used. In the present embodiment, the temperature measurement module may be connected to several sensing fibers simultaneously, so as to constitute several temperature sensing channels for simultaneous measurement.

In the present embodiment, when performing temperature measurement, a temperature value of the sensing fibers at each temperature measurement point and an environment temperature value of the isolation fibers in the isolation fiber storage region are respectively obtained. Since the sensing fibers of each temperature measurement point are coiled in the same fiber clamp, the sensing fibers of the whole temperature measurement sensing surface collectively sense the temperature of the same temperature measurement point, thus enhancing the sensitivity of the fibers to the temperature of the object to be measured.

Meanwhile, since the isolation fibers at each temperature measurement point are coiled on the back side of the same fiber clamp, the isolation fibers at each temperature measurement point measure the environment temperature of this point.

Since the respective temperature measurement points are isolated from each other by the isolation fibers in the fiber storage region, a temperature value measured by each temperature measurement point and the relative position of the temperature measurement point in the whole measurement curve are also fixed, whereby the photovoltaic panel generating an abnormal temperature may be positioned.

### Embodiment 2

The distributed fiber temperature measurement device described in Embodiment 1 may be used in fire alarm of solar photovoltaic power generation station to improve alarm accuracy by sensing a temperature change of devices such as a photovoltaic panel, a cable connector, a junction box or an inverter. Thus, the present embodiment provides a photovoltaic power station temperature measurement system based on a distributed fiber temperature measurement device, including: a fiber temperature measurement sensing device described in Embodiment 1 and a processing module. For the case of measuring the object to be measured such as a photovoltaic panel, a fiber clamp holder of the fiber temperature measurement sensing device is arranged on a surface of an objected to be measured, such as a photovoltaic panel, and a temperature measurement module acquires a temperature of the photovoltaic panel and an environment temperature around the photovoltaic panel. The processing module is configured to judge an abnormal temperature value according to the temperature of the photovoltaic panel, and identify the position of an abnormal photovoltaic panel according to the location of the fiber clamp holder with the abnormal temperature value.

In more implementations, fiber clamp holders of the fiber temperature measurement sensing devices may also be arranged on other associated electronic devices, such as cables, connectors, junction boxes and inverters to obtain the temperature of these devices and the environment temperatures around these devices respectively.

In the present embodiment, the fiber temperature measurement sensing device is arranged according to the layout of the photovoltaic panel. Light intensity values of Stokes light and anti-Stokes light at all points of temperature measurement fibers and corresponding demodulated temperature values are collected, and the temperature of each photovoltaic panel is measured and the position is identified by processing the collected light intensity values.

In the present embodiment, a grading alarm threshold is preset in the processing module, a working condition of the photovoltaic panel or other devices is judged according to the temperature of the photovoltaic panel, and a grading alarm is given. If a first-grade alarm temperature is exceeded, then the system will locate the overheated device, give an alarm signal, and instruct the maintenance personnel to repair the device or photovoltaic panel in a heating area, or the devices such as cables, connectors, junction boxes, and inverters so as to prevent the fire.

In the present embodiment, a constant temperature alarm threshold and a differential temperature alarm threshold are preset in the processing module. If it is detected that the temperature data certain photovoltaic panel is greater than the constant temperature alarm threshold, an alarm program and an acousto-optic alarm are started, and an alarm location and temperature are determined. If it is detected that a temperature difference between a certain photovoltaic panel or a certain device or certain region and the temperatures of other photovoltaic panels or device is greater than the differential temperature alarm threshold, an alarm program and an acousto-optic alarm are started, and an alarm location and temperature are determined.

As an optional implementation, the fiber clamp holder is fixed on the back side of the photovoltaic panel, the temperature measured by the sensing fibers in the fiber clamp holder is the temperature of the photovoltaic panel, the temperature measured by the isolation fibers is the environment temperature, and the isolation fibers between two temperature measurement points also facilitate the positioning of the photovoltaic panel.

As an optional implementation, in addition to the photovoltaic panel, the object to be measured may also be a cable, a connector, a junction box or an inverter; the fiber clamp holder is arranged on the surface of a device to be measured such as a cable, a connector, a junction box or an inverter; the temperature measured by the sensing fibers in the fiber clamp holder is the temperature of the device, the temperature measured by isolation fibers is the environment temperature, and the isolation fibers between two temperature measurement points also facilitate the positioning of the device.

The photovoltaic panel temperature measurement system based on the distributed fiber temperature measurement device in the present embodiment is suitable for measuring the temperature over a large area with a large number of photovoltaic panels. A working temperature of each solar photovoltaic panel can be monitored in real time, high-temperature points or overheated photovoltaic panels can be found and positioned in a large number of photovoltaic panel arrays in time, a grading alarm is given in time, the location of the overheated photovoltaic panel is determined, and the maintenance personnel is instructed to eliminate overheated devices, so as to achieve the purpose of early warning of photovoltaic panel overheating and preventing photovoltaic panels from fire.

### Embodiment 3

As shown in FIG. 2, the present embodiment provides a measurement method adopting the photovoltaic power station temperature measurement system described in Embodiment 2, including the following steps.

A temperature of an object to be measured of a photovoltaic power station is collected through a fiber clamp holder or fiber temperature measurement element/point.

A grading alarm threshold, a constant temperature alarm threshold and a differential temperature alarm threshold are preset, and an abnormal temperature value is judged according to the temperature of the object measured.

An abnormal object to be measured is positioned according to a location of a fiber clamp holder with the abnormal temperature value, and a corresponding grading alarm, constant temperature alarm, differential temperature alarm and the location of the abnormal object measured are given for maintenance.

The specific implementations of the present invention are described above with reference to the accompanying drawings, but are not intended to limit the protection scope of the present invention. A person skilled in the art should understand that various modifications or deformations may be made without creative efforts based on the technical solutions of the present invention, and such modifications or deformations shall fall within the protection scope of the present invention.

1. A distributed fiber temperature measurement device, comprising: a temperature measurement module and a group of temperature measurement fibers, the temperature measurement fibers comprising sensing fibers and isolation fibers which are arranged alternately at intervals, wherein
the sensing fibers are coiled in a fiber clamp holder to constitute temperature measurement sensing surfaces of temperature measurement elements or points;
the isolation fibers are coiled on a back side of the fiber clamp holder to constitute an isolation fiber storage region, and a distance between the adjacent fiber clamp holders or temperature measurement elements or points is adjusted by releasing and storing the isolation fibers in the isolation fiber storage region; and
the temperature measurement module is connected to the temperature measurement fibers, so as to obtain all temperature values of objects to be measured and environment temperature nearby with the use of the fiber clamp holders or temperature measurement elements or points.

2. The distributed fiber temperature measurement device of claim 1, wherein the sensing fibers are coated with heat conducting materials and arranged in a sensing surface of the fiber clamp holder to form a temperature measurement element or point according to a preset shape after being fixed with heat conducting metal.

3. The distributed fiber temperature measurement device of claim 1, wherein the isolation fibers are coiled on the back side of the fiber clamp holder according to a preset shape and thermally isolated from the fiber clamp holder using a thermal insulation material, and the isolation fibers measure an environment temperature of the fiber clamp holder accessory.

4. The distributed fiber temperature measurement device of claim 1, wherein the isolation fibers isolate the sensing fibers of the adjacent temperature measurement elements or points, and the temperature measurement module is connected to the temperature measurement fibers, and obtains all environment temperature of space between the adjacent temperature measurement points through the isolation fibers.

5. The distributed fiber temperature measurement device of claim 1, wherein the fiber clamp holder is fixed on a surface of the object to be measured through a matched clamping frame or clamping pins, so that the temperature measurement sensing surface is attached to the surface of the object to be measured to perform temperature measurement.

6. The distributed fiber temperature measurement device of claim 1, wherein the object to be measured is a photovoltaic panel, a cable connector, a junction box or an inverter.

7. A photovoltaic power station temperature measurement system, comprising the fiber temperature measurement sensing device of claim 1 and a processing module, wherein
a fiber clamp holder of the fiber temperature measurement sensing device is arranged on an object to be measured in a photovoltaic power station, and the temperature measurement module acquires a temperature of the object to be measured; and
the processing module is configured to judge an abnormal temperature value according to the temperature difference between an object to be measured and the adjacent environment temperature, and position the actual location of an abnormal object measured according to the location of the fiber clamp holder with the abnormal temperature value.

8. The photovoltaic power station temperature measurement system of claim 7, wherein a grading alarm threshold is preset in the processing module, a grading alarm is given according to a comparison result between the temperature of the object to be measured and the grading alarm threshold, if a first-grade alarm threshold is exceeded, or when the temperature of the object measured is greater than a constant temperature alarm threshold, the corresponding object measured is identified, and an alarming signal is issued for the object measured with an abnormal temperature to be disconnected and repaired.

9. The photovoltaic power station temperature measurement system of claim 7, wherein a differential temperature alarm threshold is preset in the processing module, if a temperature difference between the objects measured is greater than the differential temperature alarm threshold, an alarm program is started, and an abnormal object measured is positioned.

10. The photovoltaic power station temperature measurement system of claim 7, wherein the object to be measured is a photovoltaic panel, a cable connector, a junction box or an inverter.

11. A measurement method of the photovoltaic power station temperature measurement system of claim 7, comprising:
collecting all temperature values of all objects to be measured of a photovoltaic power station through a group of temperature measurement fibers;
presetting a grading alarm threshold, a constant temperature alarm threshold and a differential temperature alarm threshold, and judging an abnormal temperature value according to the temperature of the objects to be measured; and
positioning an abnormal object measured according to a location of the fiber clamp holder with the abnormal temperature value along the temperature measurement fiber, and giving a corresponding grading alarm, constant temperature alarm, differential temperature alarm and the location of the abnormal object measured for maintenance.
